(19) United States
(12) Patent Application Publication
(10) Pub. No.: US 2024/0312665 A1
(43) Pub. Date: Sep. 19, 2024

(54) FREESTANDING HIGH-ASPECT-RATIO GOLD MASKS FOR LOW-ENERGY, PHASE-BASED X-RAY MICROSCOPY

(71) Applicant: Creatv MicroTech, Inc., Potomac, MD (US)

(72) Inventors: Olga V. Makarova, Potomac, MD (US); Ralu Divan, Potomac, MD (US); Nicolaie Moldovan, Potomac, MD (US); David A. Czaplewski, Potomac, MD (US); Cha-Mei Tang, Potomac, MD (US)

(73) Assignee: Creatv MicroTech, Inc., Potomac, MD (US)

(21) Appl. No.: 18/377,523

(22) Filed: Oct. 6, 2023

Related U.S. Application Data
(60) Provisional application No. 63/413,898, filed on Oct. 6, 2022.

(51) Int. Cl. G21K 1/10; G21K 7/00

(52) U.S. Cl. CPC G21K 1/10; G21K 7/00

(57) ABSTRACT

High-resolution, X-ray phase contrast microscopy, a key technique with promising potential in biomedical imaging and diagnostics, is based on narrow-slit high-aspect-ratio gold gratings. We present the development, fabrication details, and experimental testing of the freestanding 10-μm-thick gold membrane masks with an array of 0.9-1.5 □m void slit apertures for a novel low-energy X-ray microscope. The overall mask size is 4 mm×4 mm, with a grating pitch of 7.5 □m, 6.0-6.6-□m-wide gold bars are supported by 3-□m-wide crosslinks at 400 □m intervals. The fabrication process is based on gold electroplating into a silicon mold coated with various thin films to form a voltage barrier, plating base, and sacrificial layer, followed by the mold removal to obtain the freestanding gold membrane with void slit apertures. We discuss key aspects for the materials and processes, including gold structures homogeneity, residual stresses, and prevention of collapsing of the grid elements. We further demonstrate the possibility to obtain high-resolution, high contrast 2D images of biological samples using an incoherent, rotating anode X-ray tube.

This application claims priority under 35 U.S.C. § 119(e) from U.S. Provisional Application Ser. No. 63/413,898, filed on Oct. 6, 2022, the entirety of which, including the contents of all the references cited therein, are incorporated herein by reference.

### BRIEF SUMMARY

Exemplary embodiments of the present disclosure provide a method comprising forming a plating base at a bottom of grooves for a uniform bottom-up electroplating.

Exemplary embodiments of the present disclosure provide a structure comprising a freestanding gold membrane mask with flat parallel gold bars.

### BRIEF DESCRIPTION OF DRAWINGS

FIG. 1 shows a schematic representation of a fabrication process where (a) Approach 1 using Cr as a lift-off layer, and (b) Approach 2 using SiNx as an insulation layer and SiO2 as a lift-off layer for creating a plating base at the bottom the grooves for subsequent gold electroplating followed by window back etch and Si removal to obtain gold membrane mask;

FIG. 2 shows an example of SEM taken at 45° tilt of Si molds with 1-μm-wide and 12-μm-tall walls with vertical etch profile (reverse taper <0.5°) (a), scallops' depth is around 30 nm (b);

FIG. 3 shows examples of SEM images taken at 45° tilt (a) gold nucleation starts on the bottom of the grooves' sidewalls, (b) electroplating does not start from the Cr plating base due to its native oxide, (c) uniform plating from the bottom up;

FIG. 4 illustrates an example of SEM image of the Si mold after dip in BOE showing removal of the plating base and silicon nitride layer;

FIG. 5 illustrates examples of SEM images (a-c) taken on the mask backside at 45° that show (a) a general view of 4×4 mm² gold membrane in Si; grid lines are not visible, being sub-resolution (b, c) 11-μm-thick freestanding gold membrane mask with an array of 0.9-μm-wide void apertures with 7.5 μm periodicity. Image (b) was obtained after focused ion beam cross sectioning; (d) 8 keV contact X-ray image of gold membrane mask with an array of 1.5-μm-wide and 400-μm-long apertures. The aperture length of 400 μm is determined by 3 μm-wide gold crosslinks;

FIG. 6 illustrates an example of an optical microscope image taken with back illumination that shows void apertures;

FIG. 7 illustrates examples of SEM images that show (a) aperture widening because of the broken silicon nitride membrane. The tensile stress of the intact SiNx membranes in the neighboring apertures pulls the gold bars apart. (b) sticking of the neighboring gold bars. Two different samples are imaged in figures (a) and (b);

FIG. 8 illustrates an example of confocal microscopy view on a portion of 2.40 mm×2.57 mm of the freestanding gold mask, with the Z coordinates exaggerated 10 times to reveal the general shape and allow flatness evaluation;

FIG. 9 shows an example of an image of a region (100×150 μm²) of the mask (a) and (b) visibility distribution for each of the apertures, calculated for each aperture and detector row;

FIG. 10 shows an example of a retrieved phase modulation for a Siemens star (a) and an intensity profile (b) extracted from the region highlighted by the line 1000; and

FIG. 11 shows examples of planar images for the retrieved transmission (a), refraction (b) and scattering (c) for a thin layer of foam. Imaging area is 1.5×1.5 mm².

### DESCRIPTION

The matters exemplified in this description are provided to assist in a comprehensive understanding of exemplary embodiments of the disclosure. Accordingly, those of ordinary skill in the art will recognize that various changes and modifications of the embodiments described herein can be made without departing from the scope and spirit of the claimed disclosure. Also, descriptions of well-known functions and constructions are omitted for clarity and conciseness.

Detailed descriptions of exemplary implementations of embodiments of the present disclosure set forth herein together with accompanying Figures describe non-limiting examples of implementations of certain exemplary embodiments of the present disclosure and aid in the description of technology associated therewith.

### 1. Introduction

X-ray phase contrast imaging (XPCI) of biological samples offers improved image quality over conventional X-ray methods. Despite this significant advantage, the technique remains restricted to research laboratories and, in particular, to synchrotron radiation sources. The possibility to transfer XPCI into real medical applications in clinical laboratories offer the prospect of creating a significant change in medical X-ray imaging. Among many XPCI techniques, two approaches emerged recently that have allowed XPCI implementations with conventional X-ray sources. One is interferometric XPCI based on three diffraction gratings, and another one is intensity-modulation X-ray phase-based imaging (IM XPCI) [7]. In the latter method, the image resolution is determined by the aperture size of the mask, hence masks with sub-micrometer apertures provide sub-micrometer resolution.

Fabrication of high-aspect-ratio (the ratio between the absorber height and the aperture width) and high-resolution gratings is extremely challenging and considerable amount of effort was put in the process development. Fabrication based on gold (Au) electroplating into the mold made in the thick layer of photoresist supported by low X-ray absorbing substrates such as silicon (Si), graphite, silicon nitride or polyimide membranes using deep x-ray-lithography is the most often used approach. X-ray lithography requires dedicated synchrotron facilities and can be considered a bottleneck of the method. Resist's low structural rigidity requires an additional lateral support for high-aspect-ratio structures with a micron-to-submicron-footprint, which reduces gratings performance.

Another method of fabricating absorption gratings is based on etching deep grooves in silicon, then filling them with gold by electroplating. Recently, centrifugal gold and tungsten particle deposition was explored for filling the grooves. Molds made of Si are rigid, their fabrication does not require X-ray lithography, but Si absorbs X-rays, limiting the photon throughput potentially reducing image contrast when polychromatic sources are used. Attempts have been made to increase mask contrast by using low absorbing substrates such as SU-8 resist or polyimide films glued on a metal frame for mechanical support. The polymer materials tend to degrade under prolonged exposure to X-rays, which can compromise mask stability over time.

Fabrication of freestanding X-ray absorption masks is a long-standing key challenge in improving image quality, as well as in reducing radiation dose, which is essential for medical applications. There are a limited number of publications on this topic and most structures are made in a resist layer, limiting the absorber thickness. Freestanding metal grids of large dimensions obtained using X-ray lithography and a graphite substrate were reported. Despite many advances in x-ray mask fabrication, fabrication of freestanding absorption gratings requires further development and innovation, and, to our knowledge, has not yet been demonstrated.

Here, we present the development, fabrication details, and experimental evaluation of freestanding 10-μm-thick gold membrane masks with an array of 0.9-1.5 μm void slit apertures with a grating pitch of 7.5 μm to be used with a low energy (8 keV) x-ray source. The 6.0-6.6-μm-wide gold bars are supported by 3-μm-wide crosslinks at 400 μm intervals.

Fabrication of such gratings is not feasible by electroplating into the resist molds because of the insufficient mechanical strength of the polymer. The presented fabrication process involves creating grooves in Si using deep reactive ion etching (DRIE), depositing a voltage barrier (SiNₓ) and a sacrificial layer (SiO₂), and forming a conductive plating base on the groove bottom for subsequent gold electroplating. A critical part of the fabrication process is the release step. In this step, the sacrificial Si is etched, and the space between the gold bars supported by the Si frame becomes void. The major challenge is to keep the long gold bars from collapsing onto each other during and after release. We have explored different release approaches utilizing a combination of DRIE with isotropic wet etch and xenon difluoride (XeF₂) vapor etch.

### 2. Experimental Section

### 2.1 Design Considerations

The mask design must meet challenging requirements such as being robust enough to perform the imaging experiments while being made of ten-micrometer-thick and six-micrometers-wide gold bars separated by micron-sized void slit apertures; the aperture length must be long enough to provide unblocked field of view, without collapse or deformation of the grating structure. We have chosen an individual aperture length of 400 μm with an overall 4×4 mm² membrane grating area. Large membrane grating area was chosen to test the method's feasibility for various X-ray imaging experiments. The ideal mask should represent an array of flat, homogeneous, parallel rectangular gold bars with rigid supports at both ends.

### 2.2 Fabrication

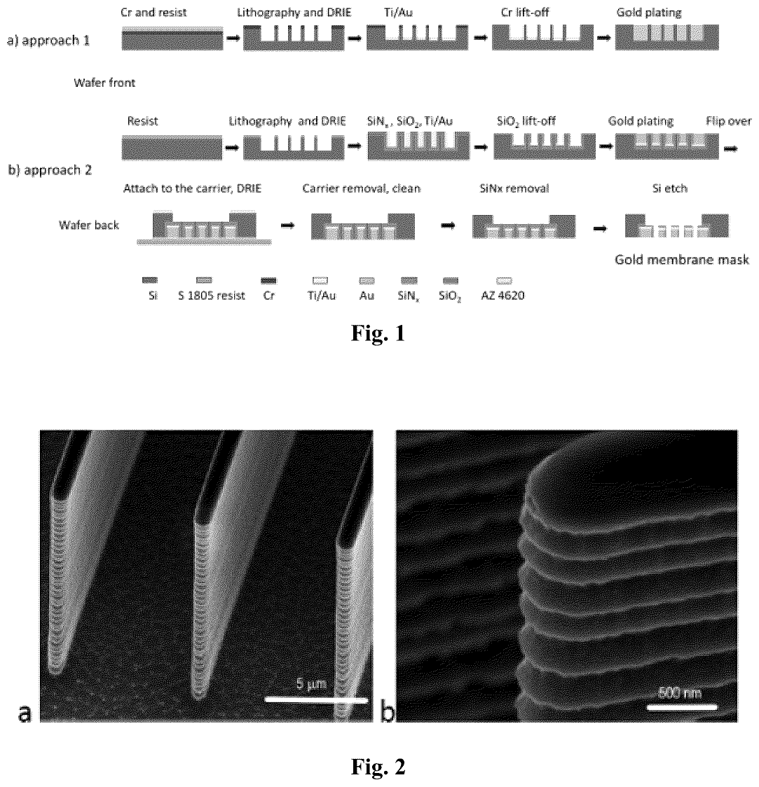

100-mm-diameter, 500-μm-thick, double side polished (100) prime Si wafers with 5-20 Ohm-cm resistivity (University Wafers) were used in all experiments. The schematic of the fabrication processes is shown in FIG. 1. Two approaches have been investigated to create a conductive plating base at the bottom of the grooves for the uniform gold filling. In the first approach (FIG. 1a), a chromium (Cr) film acted as a mask for DRIE, a Ti/Au plating base was deposited by e-beam evaporation, whilst the Cr layer was subsequently used to lift-off the Ti/Au plating base from the unwanted areas (i.e. top surface and sidewalls of the Si grooves). In the second approach (FIG. 1b), two films were used: after DRIE through a photoresist mask, the photoresist was removed, a sandwich of SiNₓ and a SiO₂ layers was deposited by plasma enhanced chemical vapor deposition (PECVD) to provide better insulation to the Si sidewalls, the Ti/Au plating base was deposited by e-beam evaporation, then the SiO₂ layer was wet etched to completely remove any plating base traces eventually deposited on the sidewalls, as well as to lift off the layer from the top of the Si grooves.

First approach. Fabrication starts with Cr (30 nm) deposition by electron beam evaporation (Temescal FC 2000) that acts as a mask for the following Si DRIE, and later as a sacrificial layer for lift-off removal of a plating base. After Cr deposition, the wafer was spin coated with a S1805 photoresist (Microchem) at 3000 rpm for 45 s, baked at 115° C. for 1 min. 1.5-μm-wide lines were lithographically patterned with a dose of 55 mJ/cm² using the 405 nm laser of the Maskless Lithography Aligner (MLA, Heidelberg 150). After resist developing with ¼ diluted 351 developer, and pattern transfer into the Cr layer using a commercial Cr etch solution (Transene 1020), the wafer was cleaved into 25 mm×25 mm size pieces, and each piece was processed separately using various fabrication parameters. The grooves in Si were etched to a depth of about 12 μm by a Bosch-like DRIE process (Oxford PlasmaLab 100 DRIE system). In the optimized recipe, the passivation and etch steps were each 3 s long. The flow rate gradually decreases for C₄F₈ from 80 standard cubic centimeter per minute (sccm) to 20 sccm and increases for SF₆ from 10 sccm to 70 sccm during seven cycles for etch step. For the passivation steps, 100 sccm of C₄F₈ gas and 1 sccm of SF₆ gas were used. A source power of 700 W is used in both steps; a RF power of 10 W is used in the deposition step and of 30 W in the etching step, pressure is 30 mTorr, the etching temperature is 10° C. After DRIE was complete, a Ti/Au (5 nm/50 nm) plating base was evaporated at a rate of 1 Å/s (Temescal FC 2000) to ensure metal deposition under normal incidence to the bottom of the Si grooves. The plating base was lifted-off from the Si top surface using the Cr etch solution (Transene 1020). The sample was electroplated at 40° C. using a commercial plating solution Techni gold 25E (Technic).

In the second approach, a resist layer served as a mask for Si DRIE. Resist application, lithography and Si etching were done as described above. After DRIE, the samples were cleaned in oxygen plasma at 200 W power for 10 min and Nanostrip solution at 120° C. for 20 min followed 10 s dip in a 10:1 buffered oxide etch (BOE) solution (Sigma-Aldrich). Then, a 250-nm thick low-stress SiNₓ layer was deposited by PECVD at 400° C. (Applied Materials P 5000) followed by a 200-nm SiO₂ layer deposited at 100° C. using SiH₄ and N₂O precursor gases (flow ratio SiH₄:N₂O=8.5:20) by PECVD (Oxford PlasmaLab 100 Inductively Coupled PECVD) and, finally, the Ti/Au (5 nm/50 nm) plating base was evaporated using Temescal FC 2000. SiO₂ was etched in a 10:1 BOE solution for 90 sec to lift-off the plating base from the groove tops and lateral walls. Since the bottom of the grooves are wider than the top, the SiO₂ under the Ti/Au layers remain mostly in place, with minor undercut, but firmly attached to the substrate. Gold is electroplated to fill the grooves using Techni gold 25E at a temperature of 40° C. and a direct current density of 1 mA/cm² (Keithley 2400 Source Meter). After electroplating, the samples were annealed on the programmable hot plate (Torrey Pines) at 350° C. for 5 hr with heating and cooling ramps of 1°/min, for building up a small tensile stress in the gold layer, to prevent buckling and collapsing of the gold bars after release. To open a window, the back side of the sample was coated with an approximately 12-μm-thick AZ 4620 resist layer (Micro Chemicals GmbH) by spin coating at 1500 rpm for 45 s, followed by 10 s spinning at 4000 rpm to reduce the edge bed. The lithography step (exposure dose of 750 mJ/cm²) was performed on a Heidelberg Instruments MLA 150 aligner, which allowed back-to-front alignment of the final mask for DRIE through-etch. After developing with 351 developer diluted 1:3, the sample was flipped over and temporally bonded to an alumina carrier wafer (Kyocera) using Dow Corning vacuum grease (Dow Corning). The window back etching using DRIE Bosch-like process was stopped when a few micrometers of bulk Si remained. The sample was detached from the carrier wafer, cleaned with isopropanol, and the resist was removed in 1165 remover (Microchem). The SiNₓ layer on the mask front was removed by immersion into 48% HF for 3 min, which was controlled by aperture color change using the optical microscope. Then, etching was continued by XeF₂ vapor isotropic etching (XETCH X4, Xactix Inc). Etching parameters were: XeF₂−1 mTorr, N₂−10 mTorr, the impulse duration 60 s. The sample was dehydrated at 115° C. for 5 min prior to etching. Examination and metrology during the fabrication process were performed using a Vega scanning electron microscope (Vega 3 SEM Tescan), a confocal microscope (VK-X1000 Keyence), and an optical microscope (Olympus). The stress of the electroplated 0.5-μm-thick gold film on a 4″ Si wafer was calculated from measuring the wafer curvature before and after gold deposition and annealing using KSA Multibeam Optical Sensor (k-Space Associates). Since the stress measurements were performed at room temperature, lower than the gold electrodeposition temperature, the measured values include a contribution from the stress arising from the differing coefficients of thermal expansion (CTE) of Si and Au.

### 2.3. Mask Testing

The mask has been evaluated using a laboratory set-up designed for IM XPCI and consisting of a rotating anode (Cu) x-ray source, a confocal multilayer monochromator selecting the Cu K lines (8 keV) and focusing the beam to a 250 μm focal spot. The detector, featuring a 1.8×1.8 mm² field of view and a 1.1 μm pixel pitch, was placed 2.2 m away from the source. The detector-to-mask distance varied between 1.5- and 25-mm. Samples were placed between mask and detector, with a mask to sample distance of 10 mm.

To assess the uniformity of the mask, visibility, which depends on mask parameters and that, in turn, affects the quality of the retrieved images, was used. It is defined as

$$V = \frac{{I}_{max} - {I}_{min}}{{I}_{max} + {I}_{min}} ,$$

with Iₘₐₓ and Iₘᵢₙ corresponding to the maximum and minimum intensity of the beamlets created by the mask apertures, respectively.

A Siemens star, comprising twenty-four 500-nm thick Au spokes placed on a 200-nm thick SiN₃ membrane, was used to assess the spatial resolution of an IM XPCI system employing the mask presented in this paper.

Additionally, a 1-mm thick foam layer was imaged and the transmission, refraction (proportional to the first derivative of the phase) and scattering contrast channels retrieved, using the method proposed in. The latter contrast channel is of particular interest in this context, as it is sensitive to length scales below the resolution of the system. Since in IM XPBI the resolution is determined by the size of the apertures, the production of micron-sized apertures makes the scattering channel sensitive to nanometric features.

### 3. Results and Discussion

### 3.1 Si Mold Microfabrication

The mold fabrication step determines the grooves profile and ultimately the quality of the mask. Vertical wall profile angle and low surface roughness are two important parameters. Anisotropic DRIE Bosch process consisting of alternating etch and deposition steps using SF₆ and C₄F₈ gases is a reliable method of obtaining high-aspect-ratio microstructures in Si. Both steps ionize the gas in an ICP source, and only the etch step applies a bias voltage to the sample. During the etch step, free fluorine radicals etch Si isotropically, and the deposition step coats the sample with a fluorocarbon polymer. The subsequent etch step removes the polymer at the base of the grooves due to the high vertical flux and momentum of the ions; however, the sidewall polymer remains relatively intact due to minimal lateral ion bombardment. Since the etch step is isotropic, the sidewall has normally a “rippled” profile with shape modulations known as scallops. The sidewall slope and the depth of the scallops depend on the ratio and duration of the etching and passivation steps. By following the strategy proposed in of using C₄F₈ during the etch step and decreasing the duration of the etch and polymerization steps, we have obtained straight and smooth Si walls. Scanning electron microscopy (SEM) images of Si molds with 1-μm-wide and 12-μm-tall walls are shown in FIG. 2. A vertical etch profile with a slight inward taper <0.5° has been achieved

(2a). The depth of the scallops is around 30 nm (2b); this is much smaller than the scallop sizes from the unmodified Bosch process, which are typically around a few hundred nanometers. The process is optimized to give a vertical profile on a certain critical feature size. Features larger than the critical feature size may have a concave profile, while those smaller than the critical feature size will have a positive profile angle.

### 3.2. Seed Layer Deposition and Gold Electroplating

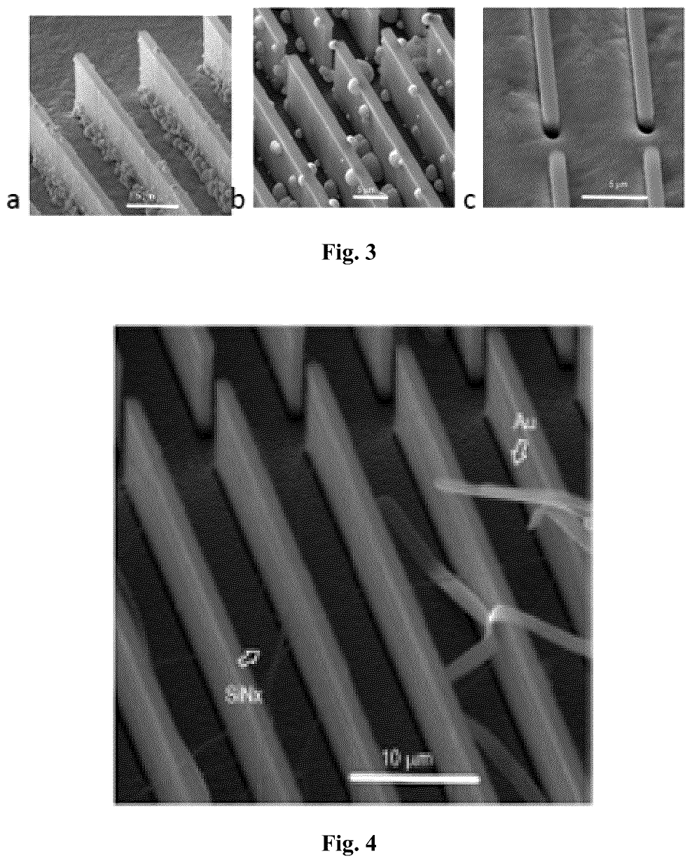

To fill the mold with the metal, two electroplating techniques are used: (i) bottom-up electroplating from the conductive bottom, (ii) a full-surface electroplating from the plating base created by atomic layer deposition (ALD) on all surfaces. The second method is used for the electroplating of gratings with 0.5 duty cycle [6,16]. This approach is hard to implement in the fabrication of the freestanding masks because of challenges in achieving uniform filling over the entire groove depth and avoiding void formation due to prematurely groove sealing. Gold deposition exhibiting mostly bottom-up evolution has been recently demonstrated using fully metallized gratings by reducing gold deposition on the groove top using bismuth. However, the undesirable gold deposition on the top of the structure still occurs and this will degrade the quality of the low-duty-cycle mask. Uniform void-free filling, essential to mask quality, can be obtained for the low-duty-cycle masks only when the plating proceeds from the bottom of the grooves. To achieve this, in the first approach (FIG. 1a), we used a sacrificial Cr layer to remove the Ti/Au plating base from the top surface structure by lift-off. Energy-dispersive X-ray spectroscopy (EDX) confirmed a gold-free top surface, but plating evolution from the groove bottom failed because the plating also proceeded on the lateral walls regardless of Si wafer resistivity (5-20 Ohm-cm), gold plating base thickness (Ti 5-10 nm/Au 30-100 nm), and current density (0.1-1 mA/cm²) (FIG. 3a). It is hard to avoid the partial deposition of gold on the lateral walls even by using orthogonal-to-the-surface e-beam evaporation. Due to higher charge density, nucleation sites on the bottom ridges and corners grow faster, leading to the non-uniform groove plating. To prevent gold deposition on the groove sidewalls, David et al. proposed to create a sacrificial shadow mask using an angled evaporation of aluminum (Al) prior to the plating base deposition. A large quantity of Al is evaporated to provide some shadowing of the sidewalls and ensure that the subsequent orthogonal evaporation steps only cover the groove bottom. This method worked well for high-aspect-ratio masks with 0.5 duty cycle; however, it has geometric limitations for the low-duty-cycle mask design. Noda et al demonstrated bottom-up groove filling by using a Cr plating base and a photoresist protection method. Following this method, we have successfully removed Cr from the structure top and from its lateral walls. However, the plating in Technic 25E failed due to gold growing from random nucleation sites on the sidewalls (FIG. 3b). This can be explained by the low conductivity of the Cr layer due to the presence of the native Cr oxide, which must be at first dissolved in the acidic gold strike solution, and then transferred to the plating solution. This is a challenging part of the method. We were trying to modify this approach by using a Cr/Au plating base instead of Cr. While Cr was easy to remove by wet etching, removal of gold traces using a diluted (1:10) gold iodine etch (Alfa Aesar) was a challenge. Either the layer was partially removed from the bottom or electroplating proceeded from both bottom and sidewalls. Seedless electroplating, using a thermal SiO₂ sidewall protection method, has been recently reported; however, uniform groove filling is quite challenging to obtain.

A new approach (figurelb) has been developed to form a plating base at the bottom of the grooves for the uniform bottom-up electroplating. We took advantage of the well-known fact that SiO₂ formed from SiH₄ and N₂O at low temperature can be easily removed by wet etch. We used SiO₂ as a sacrificial layer to lift-off the subsequently evaporated plating base from the unwanted areas. The isotropic nature of wet etching provided a means to remove SiO₂ along with the evaporated metals from the groove tops and sidewalls, while SiO₂ under the Ti/Au layers remained at the bottom of the grooves. To avoid gold nucleation on Si, an insulation layer of PECVD SiNₓ has been deposited prior to SiO₂ deposition. This approach allowed us to achieve uniform bottom-up electroplating (FIG. 3c).

To ensure good adhesion of the silicon nitride film to the sidewalls, the deposition conditions of the silicon nitride were optimized. Initial films were near stoichiometric conditions with an index of approximately 1.9. FIG. 4 shows a SEM image of the Si mold after BOE dip. Along with the plating base removal, adhesion problems of Si₃N₄ to the lateral walls was observed. By increasing the silane gas flow during the deposition, the silicon concentration in the film was increased. Consistent with previous reports, this reduced the overall residual stress in the film as the index approached 2.1. The silicon-rich, low-stress film then showed adequate adhesion properties to the sidewalls to prevent delamination and ultimately to ensure that the plating proceeded from the bottom without sidewall nucleation.

One of the major issues in obtaining a high-quality gold mask is gold residual stress, which consists of thermal stress due to mismatch between Au and Si CTE and intrinsic stress that comes from gold growth factors during electroplating. A low-stress (ca.-35 MPa) fine grain gold deposit to provide mask dimensional accuracy was obtained using parameters optimized for X-ray mask fabrication. The stress value is in a good agreement with that reported in for this plating solution.

### 3.3. Mask Release

A critical part of the fabrication process is the release step, in which the sacrificial Si is etched away and the spaces between the gold bars become voids. The major challenge is to keep the long gold bars parallel during and after release. Meeting these challenges requires reducing the bar buckling by changing the slightly compressive stress in the electroplated gold film to some tensile value by annealing.

Electroplated gold is a polycrystalline material. The microstructural characteristics of polycrystalline films define their properties and performance and can be altered (a) by electroplating parameters and (b) by annealing after electrodeposition using slow thermal ramps. Following electroplating, we have achieved a low-stress deposition essential for to the mask dimensional accuracy; subsequently, to avoid gold bars buckling, the stress must be increased to some tensile value by annealing. Through annealing, gold atoms migrate from the grain boundaries, where they are in energy-unfavorable states, towards the grain top surfaces, where they fill lower energy states, such as those favoring crystal growth with higher rates. Since atoms depart from grain boundaries, tensile stress builds up when cooling, and reaches about 200 MPa tensile in 0.5-μm-thick gold films after annealing at 200° C. for 10 min. Considering that the thickness of the to-be-released gold layer is 20 times higher, and that release of the gold membrane with a stress value close to the maximum achievable tensile stress is more stable, we have annealed the samples for 5 hr. at 350° C. Systematic evaluation of the optimal annealing parameters is outside the scope of this paper.

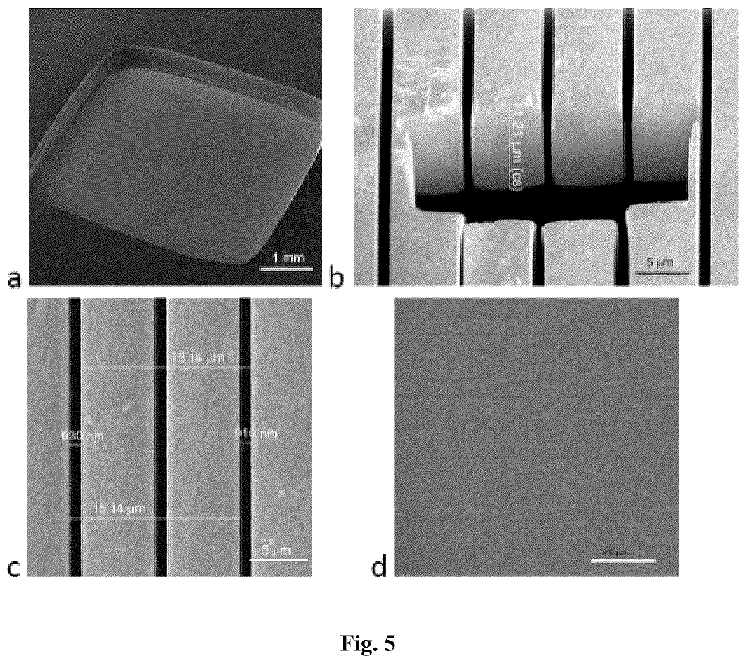

The release process started with backside Si DRIE process to open a window; the process was stopped when a few micrometers of bulk Si remained. We then continued with a gentle XeF₂ vapor phase etching to remove the remaining sacrificial Si. Although XeF₂ etching is an exothermic process, the mask can be released at almost ambient temperature by slowing the etch rate, lowering the process pressure, increasing impulse duration, and diluting XeF₂ with nitrogen. Prior to XeF₂ etching, SiNₓ insulation layer on the mask front must be removed by immersion into 48% HF. This is an important step to avoid defects caused by the broken silicon nitride layer and is discussed further in Section 3.4. Images of the flat gold membrane with homogeneous uniform gold bars and parallel apertures along their length are shown in FIG. 5.

### 3.4. Mask Evaluation

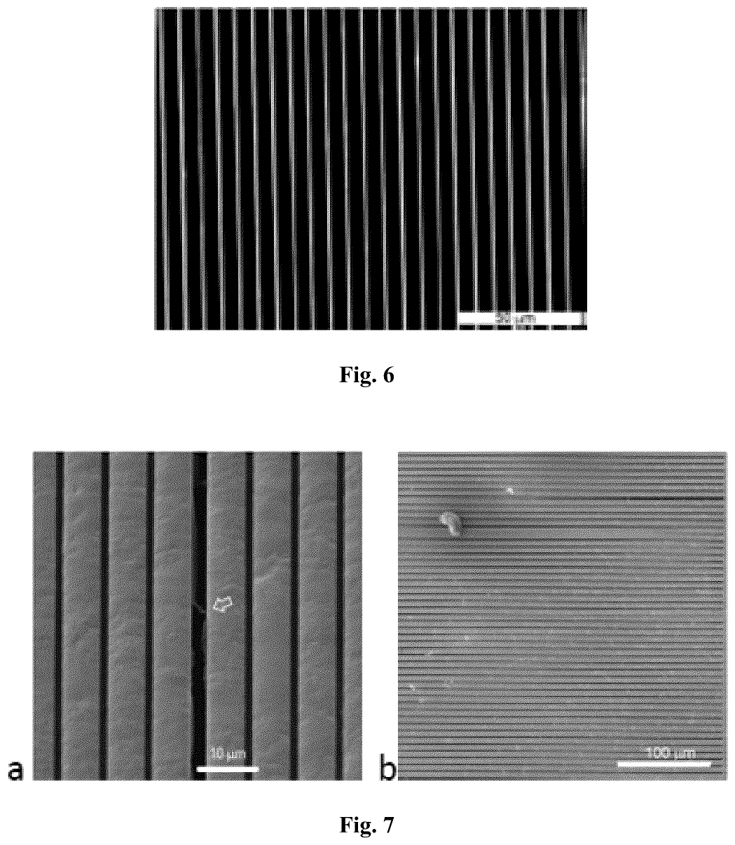

SEM and optical microscopy show an array of flat, parallel, and fully open apertures. Optical microscope image (FIG. 6) taken with back illumination shows void apertures with small residue of SiNₓ.

It is important to note that etching of SiNₓ by XeF₂ is not efficient and requires a separate processing step to remove it. Otherwise, the remaining SiNₓ causes aperture widening defects: if a silicon nitride membrane gets broken in the one of the apertures, the tensile stress of the intact SiNₓ membranes in the neighboring apertures pulls the gold bars apart as shown in FIG. 7a. Removal of the SiNₓ in liquid HF prior to XeF₂ vapor phase etching results in mostly parallel apertures. Although, few defects of gold bars sticking caused by the residue particles shown in FIG. 7b were observed manifesting that sample must be well cleaned before the release from Si. We noticed that since gold is very ductile, small forces are sufficient to produce plastic deformations in the released bars. Since the bars are long and close to each other, in some local places two adjacent bars can get close enough in a small region where there is an anomaly like a necking in the Si, or a larger gold grain, or non-uniformities in the release; if there are molecular forces that can pull the gold bars together, then the grid lines remain collapsed/bunched together.

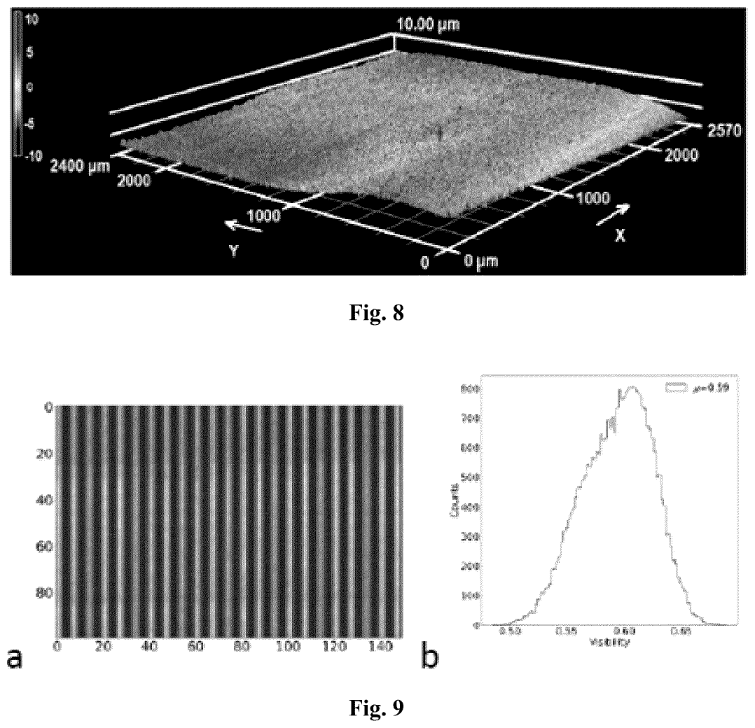

Optical flatness measurements of the gold freestanding mask were performed with a VK-X1000 Keyence laser confocal microscope and show the freestanding membrane buckling, with deviations from the ideal planar shape below 5 μm along the gold bars and below 37 μm across the gold bars over the entire gratings area. While requirements for out-of-plane grid deformations are permissive for the XPCI, portions of 2×2 mm², as necessary for the experiments, can be selected from the middle of the membrane, with deviations from flatness bellow 5 μm in both directions, as shown in FIG. 8. The grid was aligned with the slits along the x direction.

Membrane buckling suggests that there is not enough tensile stress in electroplated gold to keep the gold bars straight. With annealing time increase, it should be possible to reduce the gold bars buckling, and this is a subject for further work. Flatness of the membrane can also be improved by reducing the size of the window in Si. If larger mask area is needed, a thin layer (˜5 μm) of polymer such as polyimide or polymethyl methacrylate (PMMA) spun over the front side of the mask prior to the Si etching using XeF₂ improves membrane flatness substantially. The downside of this approach is that polymers under X-rays are degrading with time. Reducing the length of the aperture would also improve membrane rigidity though is not desirable because of reducing field of view.

A mask with 1.5-μm-wide apertures has been tested with 8 keV X-rays. FIG. 9 shows an x-ray transmission image of the mask acquired with a short mask-detector distance (1.5 mm), in order to reduce source penumbra effects and interference between apertures. The visibility distribution (see FIG. 9b), calculated over each aperture and for each detector row has a relative width of 55% expressed as +1 standard deviation, suggesting a good degree of uniformity. It is important to note that the visibility measured with this experiment is the result of all components of the image formation chain, including variability of the focal spot size across the FOV and detector's pixel-to-pixel gain and noise variations, both factors contributing to broadening the visibility distribution. Since visibility is one of the parameters that determine image quality of the retrieved images in IM XPCI, visibility uniformity across the mask translated into uniformity in the retrieved images.

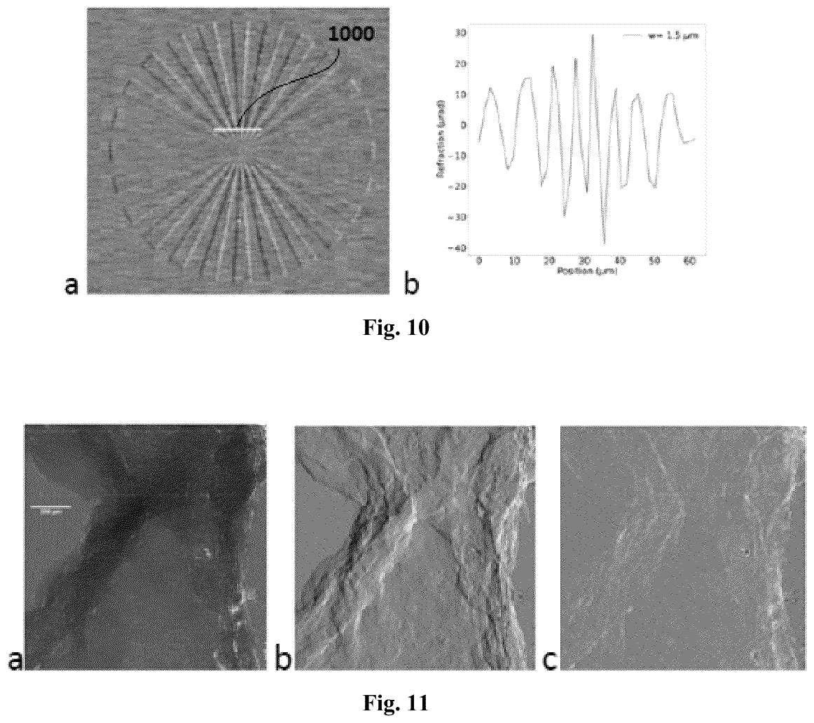

The retrieved refraction image (differential phase) of the Siemens star is shown in FIG. 10a. The directionality of phase sensitivity is visible when comparing vertically and horizontally oriented spokes, which, in this case, is maximum for the vertical ones, i.e., for horizontal interfaces. The modulation at a radial distance corresponding to a spoke width of 1.5 μm (FIG. 10b, central region) suggests a resolution comparable to or better than the aperture width, as theorized in and demonstrated in. Modulation is reduced at both sides of the intensity profile of FIG. 10b since the varying spoke orientation reduces the signal component along the direction of phase sensitivity. Similarly, for smaller spokes' width the contrast of the resolved features progressively decreases, until they can no longer be resolved individually in the center of the Siemens star.

Exemplar images of retrieved transmission, refraction and scattering for a thin foam layer, imaged with an 8 keV x-ray beam, indicating the complex refraction index of the imaged sample as n=1−δ+iβ, the transmission image (FIG. 11a) and the refraction image (FIG. 11b) represent planar maps proportional to its imaginary part R and to the unit decrement of its real part δ, respectively. The refraction image shows the capability of the system to detect interfaces of the micro-structures constituting the sample. Additionally, the scattering contrast channel (FIG. 11c) highlights the presence of structures below the resolution limit of the system, i.e. on a sub-micron scale in this case.

### 4. Conclusion

A microfabrication process was developed to fabricate the mask prototypes for a novel low-energy, phase-based X-ray microscope. The masks are 10-11-μm-thick freestanding gold membranes 4×4 mm² in size with an array of 0.9-μm-1.5-μm-wide and 400-μm-long void slit apertures with 7.5-μm periodicity. An aspect ratio of 12 has been demonstrated. The method developed herein allows for further increase in the aspect ratio as we target higher resolution (i.e. narrower apertures) or higher x-ray energies, which are among our plans for future development. We overcame several challenges in the fabrication process and have (a) optimized the DRIE Bosch process to obtain 12-μm-tall and 0.9-1.5 μm-wide structures with smooth vertical walls, (b) developed a technique to form a plating base at the bottom of the Si grooves for bottom-up electroplating. A SiNₓ layer was used to insulate the structure's lateral and top surfaces, and a SiO₂ sacrificial layer was used to remove the evaporated plating base from the unwanted areas by lift-off, (c) achieved uniform bottom-up gold electrodeposition, (d) tailored residual stress in electroplated gold to keep gold membrane flat upon release from Si, (e) obtained the freestanding gold membrane mask with flat parallel gold bars. From the presented data, aperture length and the overall mask size, homogeneity of the electrodeposited gold layer, SiNₓ and gold residual stresses, and SiNₓ layer removal from the mask front are crucial factors to control the uniformity of the released mask. We further demonstrated the possibility to obtain high-resolution high-contrast 2D images of biological samples using an incoherent, rotating anode X-ray source; while in this case, the beam was monochromatized; use of polychromnatic spectra with low average energy is equally possible. Future work will focus on further reducing aperture width down to 500 nm and on the optimization of the fabrication parameters for reliable manufacturing of the freestanding masks.

While the present disclosure has been shown and described with reference to certain exemplary embodiments thereof, it will be understood by those skilled in the art that various changes in form and details may be made therein without departing from the spirit and scope of the present disclosure.

We claim:

1. A method comprising:
forming a plating base at a bottom of grooves for a uniform bottom-up electroplating.

2. A structure comprising:
a freestanding gold membrane mask with flat parallel gold bars.
